(19) United States
(12) Patent Application Publication
(10) Pub. No.: US 2023/0287922 A1
(43) Pub. Date: Sep. 14, 2023

(54) TORQUE LIMITING FASTENER

(71) Applicant: A. Y. McDonald Mfg. Co., Dubuque, IA (US)

(72) Inventor: Thomas W. Hast, Dubuque, IA (US)

(21) Appl. No.: 17/692,674

(22) Filed: Mar. 11, 2022

(51) Int. Cl. F16B 31/02

(52) U.S. Cl. CPC F16B 31/021

(57) ABSTRACT

A torque limiting hex head bolt with a cap overmolded on the hex head. The cap surrounds the hex head with a surrounding lip underlying a hex head surface facing the bolt distal end. First and second cap hex heads are aligned about the bolt axis on its proximal end with a weakened portion between the cap hex heads whereby the first cap hex head breaks from the cap when an excess torque is applied to the first cap hex head. A spacer extends axially in the distal direction from the hex head surface facing the distal end, and has an axial dimension at least equal to the axial dimension of the cap surrounding lip. A flange extends radially outwardly from the torque limiting cap, wherein the flange and the cap weakened portion are between the first and second cap hex heads.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates to fasteners, and more particularly to fasteners which limit the torque which may be applied when used to fasten an object.

### BACKGROUND OF THE INVENTION

Almost needless to say, fasteners such as bolts are used in a variety of applications to secure two components together or to secure a component to itself (e.g., when securing two parts of an object together such as when pulling two ends of a saddle together to tighten the saddle around a pipe). In many such applications, particularly where a bolt draws the two components together, tightening the bolt too much can damage the component or components (e.g., overtightening a saddle can damage the saddle and/or the saddle surrounded cylindrical pipe).

In municipal water systems, for example, residential connections are made by tapping into a large diameter water main to connect to a smaller diameter service line running to the residence. Such connections use a saddle which circles the water main with opposite ends secured together by, in some structures, one or more bolts. Such bolt(s) secure together opposite sides of the saddle encircling the water main and are tightened to compress a sealing gasket against the water main to prevent leaking around the tapped opening for the residential connection.

Repair clamps are used similarly in water systems to repair leaks in a water line, with the repair clamp secured around the water line and over a leaking portion with, in some structures, bolt(s) tightened to draw opposite sides of the repair clamp together to compress a circumferential gasket around the water line and under the repair clamp to block leaking.

It is often necessary to limit the force applied by the bolt(s) in order to protect against damage to the structure. For example, with water mains such as described, if the saddle or repair clamp is tightened too much, it can cause the water main itself to buckle and lose its cylindrical shape. Therefore, such saddles and repair clamps have generally been mounted and tensioned using bolts and a tool capable of applying torque to those bolts. For proper installation they generally require that the torquing tool be capable of measuring or limiting that torque.

However, it should be appreciated that when using a tool which must be adjusted to limit the torque it can apply, errors can occur—whether by the worker failing to appreciate that the tool be set to have a torque limit, or even when appreciating the need by setting the tool to operate with an incorrect torque limit.

In order to try to ensure that the proper torque limit is observed, fasteners including bolts and/or add-on adapters have been provided which themselves have torque limits (i.e., will break off when the applied torque exceeds the selected torque limit). Such structures are illustrated, for example, in Paterson et al. PCT Publication WO 92/03262 (Mar. 5, 1992), Holmann et al. U.S. Pat. No. 5,299,474 (Apr. 5, 1994), Balderrama et al. U.S. Pat. No. 10,113,579 (Oct. 30, 2018), Goldberg et al. U.S. Pat. No. 10,514,054 (Dec. 24, 2019), and Tamm et al. U.S. Pat. No. 11,098,744 (Aug. 24, 2021).

However, it should be appreciated that such torque limiting structures present their own limitations. Off-axis loading (applying a torque around an axis which is not aligned with the axis of the bolt) when tightening the bolt can cause add-on adapters to pop off the bolt head. Further, it can be difficult to remove the bolt (i.e., rotate it in the reverse direction) after the limiting head breaks off, and similarly can make adjustments difficult after the limiting head breaks off. Still further, removing such bolts can require different size tools when tightening and removing the bolt.

The invention disclosed herein addresses one or more of these problems.

### SUMMARY OF THE INVENTION

In one aspect of the disclosure, a hex head bolt includes an axial bolt shaft with a threaded surface, a hex head integral with the proximal end of the bolt shaft, and a torque limiting cap overmolded on the hex head. The hex head includes a surface at right angles to the shaft axis and facing the shaft distal end. The cap surrounds the shaft hex head and includes a surrounding lip underlying the hex head surface facing the distal end. The cap also includes a first cap hex head aligned about the shaft axis on its proximal end and a weakened portion whereby the first cap hex head breaks from the torque limiting cap when a torque is applied to the first cap hex head which exceeds the torque limit. A spacer extends axially in the distal direction from the hex head surface facing the distal end, with the metal spacer having an axial dimension at least about equal to the axial dimension of the cap surrounding lip.

In one form of this aspect of the disclosure, the spacer is a washer around the distal end of the bolt shaft. In an alternate form, the spacer is an integral part of the bolt shaft.

In another form of this aspect of the disclosure, the torque limiting cap includes a second cap hex head between the first cap hex head and the bolt shaft integral hex head. In a further form, the bolt shaft integral hex head, the first cap hex head and the second cap hex head are the same size with all adapted to be torqued by a single size wrench. In another further form, a flange extends radially outwardly from the torque limiting cap, wherein the flange and the cap weakened portion are between the first and second cap hex heads.

In still another form of this aspect of the disclosure, a flange extends radially outwardly from the torque limiting cap, wherein the flange is between the first cap hex head and the cap weakened portion.

In yet another form of this aspect of the disclosure, the torque limiting cap is molded of a hard plastic material adapted to retain the body portion on the bolt integral hex head when off-axis torque is applied to the torque limiting cap.

In another form of this aspect of the disclosure, the hex head bolt is adapted to secure an object, and includes a spacer adapted to secure the hex head right angle distal facing surface at a selected axial distance from the object, wherein the body surrounding lip has an axial dimension no greater than about the selected axial distance. In a further form, the spacer is metal. In another further form, the spacer is less compressible than the body surrounding lip.

In another aspect of the disclosure, a torque limiting cap for a hex head bolt includes a body portion, a first cap hex head adapted to be aligned about the shaft axis with the bolt shaft integral hex head, and a weakened portion whereby the first cap hex head breaks from the torque limiting cap when a torque is applied to the first cap hex head which exceeds a selected torque limit. The body portion is adapted to surround the bolt integral hex head whereby the torque limiting cap and surrounded bolt integral hex head rotate together around the axis. The cap body portion further includes a surrounding lip having a surface adapted to face the proximal end of a hex head bolt and adapted to overlap with the hex head right angle distal facing surface.

In one form of this aspect of the disclosure, the cap is molded of a hard plastic material adapted to retain the body portion on the bolt integral hex head when off-axis torque is applied to the torque limiting cap.

In another form of this aspect of the disclosure, the torque limiting cap is adapted to secure an object with a hex head bolt, with the cap further including a spacer adapted to secure the hex head right angle distal facing surface at a selected axial distance from the object, wherein the body surrounding lip has an axial dimension no greater than about the selected axial distance.

In still another form of this aspect of the invention, a second cap hex head is between the first cap hex head and the bolt shaft integral hex head. In a further form, the bolt shaft integral hex head, the first cap hex head and the second cap hex head are the same size with all adapted to be torqued by a single size wrench.

In yet another form of this aspect of the invention, a flange extends radially outwardly from the torque limiting cap, wherein the flange is between the first cap hex head and the cap weakened portion.

In still another aspect of the disclosure, a torque limiting cap for a hex head bolt includes a body portion adapted to engage a bolt integral hex head whereby the torque limiting cap and engaged bolt integral hex head rotate together about the axis, a first cap hex head adapted to be aligned about the shaft axis with the bolt shaft integral hex head, a second cap hex head between the first cap hex head and the bolt shaft integral hex head and adapted to be aligned about the shaft axis with the first cap hex head and the bolt shaft integral hex head, and a weakened portion between the first and second cap hex heads whereby the first cap hex head breaks from the second cap hex head when a torque is applied to the first cap hex head which exceeds a selected torque limit, and wherein the bolt shaft integral hex head, the first cap hex head and the second cap hex head are the same size with all adapted to be torqued by a single size wrench.

In one form of this aspect of the disclosure, a flange extends radially outwardly from the torque limiting cap, wherein the flange is between the first cap hex head and the cap weakened portion.

Other objects, features, and advantages of the invention will become apparent from a review of the entire specification, including the appended claims and drawings.

### BRIEF DESCRIPTION OF THE DRAWINGS

FIG. 1 is a side view of a first embodiment of an advantageous torque limiting fastener as disclosed herein;

FIG. 2 is a cross-sectional view of the torque limiting fastener of FIG. 1;

FIG. 3 is a cross-sectional view illustrating the fastener illustrated in FIGS. 1-2 as used to secure the band of a saddle surrounding, for example, a cylindrical water main;

FIG. 4 is a side view of a second embodiment of an advantageous torque limiting fastener as disclosed herein;

FIG. 5 is a cross-sectional view of the torque limiting fastener of FIG. 4;

FIG. 6 is a perspective view of the torque limiting fastener of FIGS. 4-5; and

FIG. 7 is a cross-sectional view illustrating the fastener illustrated in FIGS. 4-6 as used to secure the band of a saddle surrounding, for example, a cylindrical water main.

### DETAILED DESCRIPTION OF THE PREFERRED EMBODIMENT

Disclosed herein is a torque limiting bolt including a cap which will be retained on the bolt even if an off-axis load is applied (i.e., if the tool being used is at an angle whereby a torque is applied around an axis which is skewed from the bolt axis). The disclosed bolt cap also has a hex head which breaks off when more than a selected torque limit is applied to tighten the bolt connection and yet still functions advantageously to thereafter adjust the connection as well as to loosen and/or remove the bolt.

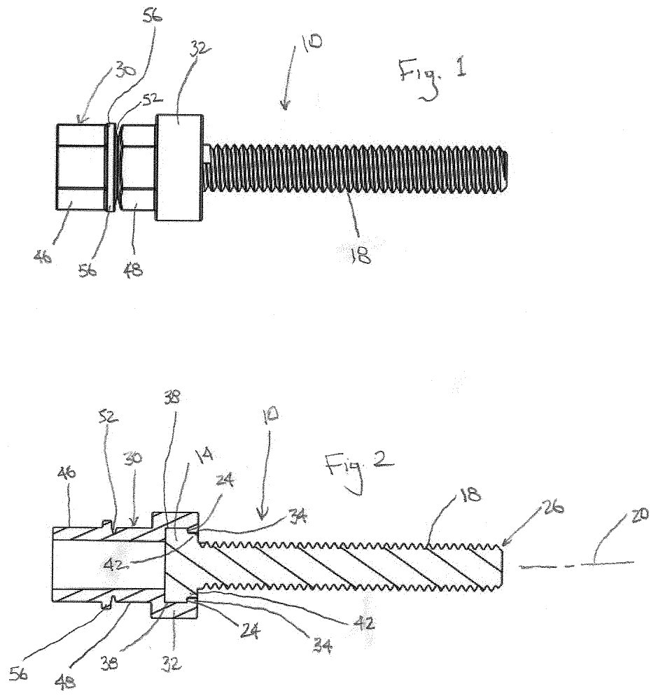

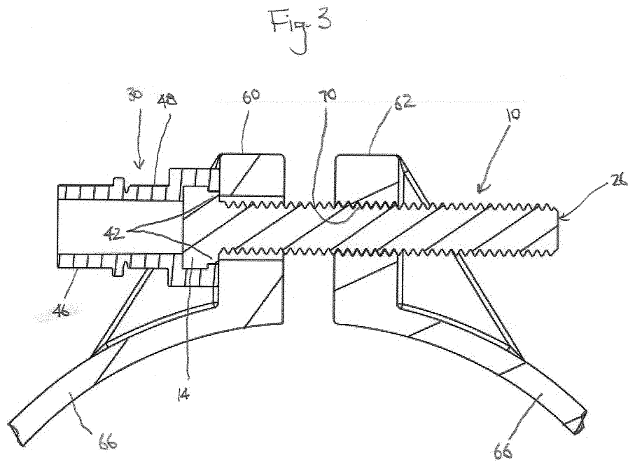

FIGS. 1-2 illustrate one version of the torque limiting bolt 10. The bolt 10 includes a hex head 14 (see FIG. 2) on the proximate end of a threaded shaft 18 extending along an axis 20. The underside of the bolt hex head 14 defines an ring surface 24 at right angles to the axis 20 and facing the distal end 26 of the bolt 10.

A plastic cap 30 includes a body portion 32 which may be advantageously molded over the bolt hex head 14 with an annular lip 34 underlying the bolt hex head ring surface 24. Such structure enables the bolt 10 and cap 30 to be secured together to simplify inventory of parts and use in the field by avoiding the need to handle two separate parts when installing. Further, engagement of the lip 34 with the ring surface 24 helps to ensure that the cap 30 will be retained on the bolt hex head 14 even if an off-axis torque is applied. Off-axis torque introduces a force which tends to twist one side of the cap 30 up from the bolt hex head, but the underlying lip 34 of the cap 30 around the bolt surface 24 retains the cap 30 on the bolt hex head 14 against those forces.

The bolt hex head 14 has a non-cylindrical outer surface 38 such as can be engaged by a tool such as a wrench to apply torque to rotate the bolt 10 around the axis 20.

It should be noted that references herein to hex heads, including in the claims, is for convenience of reference using common bolt head terminology. References to hex heads as used herein, however, are intended to encompass any configuration in which the cap 30 may be secured to the head 14 of the bolt 10 for rotation together about the axis 20. Such configurations would include any non-cylindrical bolt head shape, including oval shapes and shapes with any number of sides (e.g., not only hexagonal as is standard but also pentagonal, octagonal, etc.) and others such as slotted connections and non-cylindrical recesses in which Allen wrench type connections may be made.

The bolt head 14 on its distal side includes an integral ring spacer 42 made of the same hard material (typically metal) as the bolt 10 and having an axial dimension of at least about as large as the axial dimension of the cap lip 34. It should be appreciated that (as shown in FIG. 3 and described hereinbelow) the spacer 42 will prevent the bolt 10 cap lip 34 from being compressed and damaged when the bolt head 14 is tightened against a surface.

The cap 30 includes two hex heads 46, 48 which are axially aligned with each other and with the bolt hex head 14. The cap 30 includes a weakened portion 52 between the two cap hex heads 46, 48, with the weakened portion 52 designed based on material, shapes and dimensions so that when more than a selected torque is applied to the first (outer) hex head 46 by a suitable tool such as a wrench (including auto-impact drivers), the cap hex head 46 will break off, thereby ensuring that the bolt 10 will not be overtightened.

A flange 56 extends radially outwardly from the cap hex head 46 to ensure that when the bolt 10 is being tightened, the tool (wrench) will engage only the first cap hex head 46. It should be appreciated that by positioning the flange 56 between the first cap hex head 46 and the weakened portion 52, the flange 56 will break off with the first cap hex head 46. When that occurs, it ensures that if adjustment is required, or when the bolt needs to be loosened or removed, the tool will readily engage the other cap hex head 48 and a torque greater than the limited torque for the first cap hex head 46 may be applied (as may often be necessary when removing a bolt 10 after it has been in place for long periods of time).

It should also be appreciated that, as best seen in FIGS. 1-2, this configuration allows for all three hex heads (bolt hex head 14 [see particularly FIG. 2] and first and second cap hex heads 46, 48) may be of the same size—that is, may all be torqued by a tool of the same size. The tool which engages the first cap hex head 46 will also function with the second cap hex head 48 after the first cap hex head 46 is broken away. Further, should the cap 30 in some way be broken off of the bolt hex head 14, the same tool may be used with the exposed bolt hex head 14. The ability to use the same size tool for all tasks can significantly enhance productivity and efficiency when connecting and disconnecting fasteners

FIG. 3 illustrates the use of a bolt 10 such as described in FIGS. 1-2, wherein two sides 60, 62 of a band 66 wrapped, for example around a pipe. As illustrated, the distal end 26 of the bolt 10 is screwed through a threaded opening 70 on one band side 62 and pulls the bolt hex head 14 against the other band side 60. When the torque limit is applied to the first cap hex head 46, the band 66 will be sufficiently tightened according to the design specifications at which point the first cap hex head will break off at the weakened portion 52. In that condition, it should be appreciated that the hard spacer 42 will bear the axial force of the one band side 60, thereby protecting the cap underlying lip 34 from being damaged, and thereby ensuring that application of an off-axis load will not break the cap 30 off the bolt hex head 14.

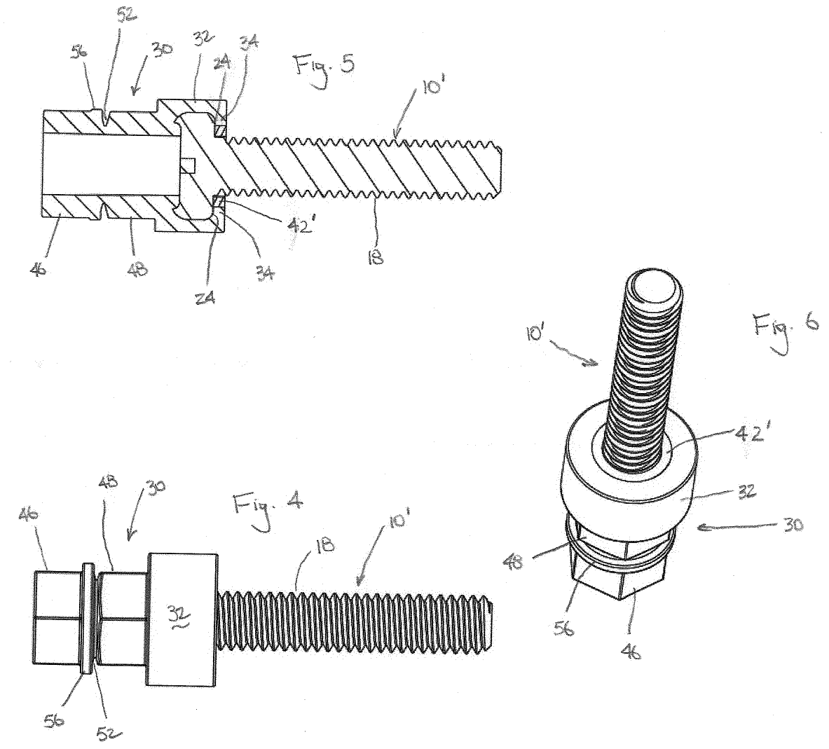

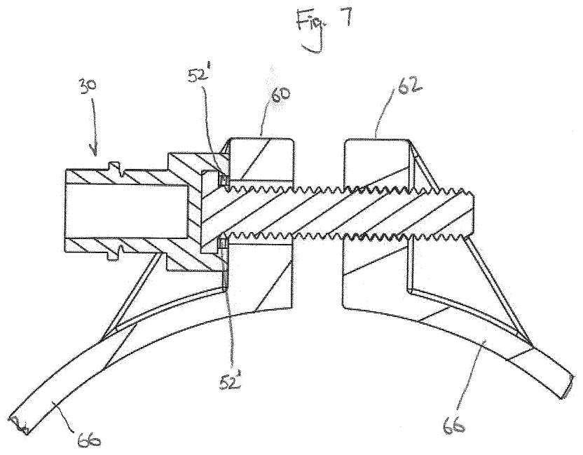

FIGS. 4-7 illustrate an alternative embodiment of the bolt 10 described in FIGS. 1-3. The components of this embodiment having the same configuration as the FIGS. 1-3 embodiment have been given the same reference numerals as used with the corresponding components of FIGS. 1-3.

Specifically, this alternative embodiment differs from the first described embodiment in that the spacer 42′ is a separate washer and is not an integral part of the bolt 10′. It should be appreciated that this spacer 42′ will advantageously function in the same manner—that is, it will protect the underlying lip 34 (made of more easily compressible plastic) from being damaged when the bolt 10′ is tightened and thereby ensure that application of an off-axis load will not break the cap 30 off the bolt hex head 14. Moreover, use of a separate spacer 42′ may allow use of standard bolts without requiring special forming or machining of the bolt 10′.

It should be appreciated that torque limiting fasteners such as disclosed herein may facilitate use of the fasteners in all sorts of conditions and over extended periods of time, including not only during initial fastening but also thereafter to make adjustments and/or to remove the fastener. Further, such fasteners protect against the cap being removed from the bolt head even when the user improperly uses the tool at an angle whereby off-axis torque is applied.

Still other objects and advantages of the fasteners disclosed herein may be had from review of the specification and drawings hereof

1. A hex head bolt, comprising:
a bolt shaft extending along an axis from a proximal end to a distal end, said shaft including a threaded surface;
a hex head integral with the proximal end of the bolt shaft, said hex head including a surface at right angles to said shaft axis and facing said distal end;
a torque limiting cap overmolded on said hex head, wherein said cap
surrounds the shaft integral hex head and includes a surrounding lip underlying the hex head surface facing the distal end,
includes a first cap hex head on its proximal end and aligned about said shaft axis with said bolt shaft integral hex head, and
includes a weakened portion whereby said first cap hex head breaks from said torque limiting cap when a torque is applied to said first cap hex head which exceeds said torque limit; and
a spacer extending axially in the distal direction from the hex head surface facing the distal end, said metal spacer having an axial dimension at least about equal to the axial dimension of the cap surrounding lip.

2. The hex head bolt of claim 1, wherein said spacer is a washer around the distal end of the bolt shaft.

3. The hex head bolt of claim 1, wherein the spacer is an integral part of said bolt shaft.

4. The hex head bolt of claim 1, wherein said torque limiting cap includes a second cap hex head between said first cap hex head and said bolt shaft integral hex head.

5. The hex head bolt of claim 4, wherein said bolt shaft integral hex head, said first cap hex head and said second cap hex head are the same size with all adapted to be torqued by a single size wrench.

6. The hex head bolt of claim 4, further comprising a flange extending radially outwardly from the torque limiting cap, wherein said flange and said cap weakened portion are between said first and second cap hex heads.

7. The hex head bolt of claim 1, further comprising a flange extending radially outwardly from the torque limiting cap, wherein said flange is between said first cap hex head and said cap weakened portion.

8. The hex head bolt of claim 1, wherein said torque limiting cap is molded of a hard plastic material adapted to retain said body portion on said bolt integral hex head when off-axis torque is applied to the torque limiting cap.

9. The hex head bolt of claim 1 adapted to secure an object, further comprising a spacer adapted to secure said hex head right angle distal facing surface at a selected axial distance from said object, wherein said body surrounding lip has an axial dimension no greater than about said selected axial distance.

10. The hex head bolt of claim 9, wherein said spacer is metal.

11. The hex head bold of claim 9, wherein said spacer is less compressible than said body surrounding lip.

12. A torque limiting cap for a hex head bolt having a threaded bolt shaft extending axially from an integral hex head at its proximal end to a distal end, said shaft including a threaded surface and said hex head including a surface at right angles to said shaft axis and facing said distal end, said torque limiting cap comprising:
a body portion adapted to surround said bolt integral hex head whereby the torque limiting cap and surrounded bolt integral hex head rotate together around said axis, said body portion further including a surrounding lip having a surface adapted to face said proximal end of a hex head bolt and adapted to overlap with said hex head right angle distal facing surface;
a first cap hex head adapted to be aligned about said shaft axis with said bolt shaft integral hex head; and
a weakened portion whereby said first cap hex head breaks from said torque limiting cap when a torque is applied to said first cap hex head which exceeds a selected torque limit.

13. The torque limiting cap of claim 12, wherein said cap is molded of a hard plastic material adapted to retain said body portion on said bolt integral hex head when off-axis torque is applied to the torque limiting cap.

14. The torque limiting cap of claim 12 adapted to secure an object with a hex head bolt, further comprising a spacer adapted to secure said hex head right angle distal facing surface at a selected axial distance from said object, wherein said body surrounding lip has an axial dimension no greater than about said selected axial distance.

15. The torque limiting cap of claim 12, further comprising a second cap hex head between said first cap hex head and said bolt shaft integral hex head.

16. The torque limiting cap of claim 15, wherein said bolt shaft integral hex head, said first cap hex head and said second cap hex head are the same size with all adapted to be torqued by a single size wrench.

17. The torque limiting cap of claim 12, further comprising a flange extending radially outwardly from the torque limiting cap, wherein said flange is between said first cap hex head and said cap weakened portion.

18. A torque limiting cap for a hex head bolt having an axially extending threaded shaft, comprising:
a body portion adapted to engage said bolt integral hex head whereby the torque limiting cap and engaged bolt integral hex head rotate together about said axis;
a first cap hex head adapted to be aligned about said shaft axis with said bolt shaft integral hex head;
a second cap hex head between said first cap hex head and said bolt shaft integral hex head and adapted to be aligned about said shaft axis with said first cap hex head and said bolt shaft integral hex head; and
a weakened portion between said first and second cap hex heads whereby said first cap hex head breaks from said second cap hex head when a torque is applied to said first cap hex head which exceeds a selected torque limit;
wherein said bolt shaft integral hex head, said first cap hex head and said second cap hex head are the same size with all adapted to be torqued by a single size wrench.

19. The torque limiting cap of claim 18, further comprising a flange extending radially outwardly from the torque limiting cap, wherein said flange is between said first cap hex head and said cap weakened portion.
